(19) United States
(12) Patent Application Publication
(10) Pub. No.: US 2016/0137174 A1
(43) Pub. Date: May 19, 2016

(54) Method for Electrically Controlling Trailer Brakes

(71) Applicant: Anthony Valenzano, Archbald, PA (US)

(72) Inventor: Anthony Valenzano, Archbald, PA (US)

(21) Appl. No.: 14/933,814

(22) Filed: Nov. 5, 2015

Related U.S. Application Data
(60) Provisional application No. 62/076,063, filed on Nov. 6, 2014.

(51) Int. Cl. B60T 8/17; B60T 8/171

(52) U.S. Cl. CPC B60T 8/1708; B60T 8/171

(57) ABSTRACT

A system and method for controlling trailer brakes utilizing disc brake energy dissipation readings of the towing vehicle. Heating of the towing vehicle brakes above a dynamic set point and at a given vehicle speed, indicates the stopping load presented by a trailering vehicle. This controller responses to the increasing heating of the tow vehicle brakes by increasing the braking signal to the trailering brakes. Once the braking to the trailering vehicle has been increased sufficiently the towing vehicles brake temperatures level off and the system continuous to balance the two braking systems.

### CROSS REFERENCE TO RELATED APPLICATIONS

This application claims priority to U.S. provisional application Ser. No. 62/076,063 filed on Nov. 06, 2014, and incorporates the same by reference as if set forth herein in its entirety.

### STATEMENT AS TO FEDERALLY SPONSORED RESEARCH

Not applicable.

### BACKGROUND OF INVENTION

1. Field of Invention

The invention relates generally controlling brakes on trailering vehicles. Particularly, the invention relates using information about energy being dissipated in the towing vehicle's braking system to assist in formulating the braking power or signal sent to the trailering vehicle's brakes.

2. Background of Invention

Towing trailers over a certain weight are required to have a trailer braking system. Some of those braking systems are hydraulic (surge) brakes, others are air driven, and lastly many are electrically driven. The biggest challenge for these systems is to control the trailer brakes in a way that is proportional to the braking of the tow vehicle. Surge brakes have an advantage in that they are activated when the trailer in tow pushes against the tow vehicle, which in turn activates the brakes and slows the trailer. However, surge brakes cannot be used with other towing accessories, such as weight distribution systems and anti-sway systems. They also have disadvantages when backing. The operator does not have control over the functioning of the surge system. Surge brakes are used largely in rental applications and boating, but not at all for travel trailers and cargo trailers, which normally need anti-sway devices. The idea behind the described invention is to get the proportional response similar to surge brakes, in an electrically activated system, where the two braking systems are independent, unlike air braking systems where they are centrally controlled. Said differently, the invention is a method of using one braking system to control the second independent braking system.

### Objects and Advantages

Current practice with electrically activated brakes is to measure the de-acceleration of the tow vehicle and respond to that de-acceleration by adding braking to the trailer. Unfortunately, more often then not, this results in the further de-acceleration of the tow vehicle, which further increases the braking to the trailer. This results in a runaway braking situation. This runaway action is dealt with by either stopping the braking activity, manually using a button to activate the trailer brakes, or by setting the trailer brakes so low that they don't really contribute to the braking. All three of these methods reduce the safety of the braking system by either distraction the operator, or by greatly relying on the vehicle brakes, which can become dangerously overheated. The invention using the most direct information available to determine if the vehicle brakes are over working, which is the energy dissipation of the tow vehicle's brake discs or drums. This method ensure the braking is balanced between the tow vehicle and trailering vehicle.

Other methods of activating the electrical brakes is a time-based response, used on very inexpensive controllers, which just increases the trailer braking over time as the brake is depressed. This system has been largely surpassed by the proportional method. Another method that has been tried is to measure the pressure applied to the brakes by the operator. This requires interfering with the operation of the brakes, by installing a hydraulic pressure sensor, or a foot pressure sensor. Also, this doesn't exactly measure the braking energy of the brakes, as they change with temperature and pad condition.

Some brake controllers use ambient temperature readings to correct for operations of components. This system uses temperatures readings, not of ambient air, but as an indication of energy dissipation of the braking system.

### SUMMARY OF INVENTION

The concept of the invention is to directly measure the braking energy of the tow vehicle brakes by means of measuring the temperature of the braking discs themselves. As the kinetic energy of the of the vehicle is converted to heat energy in the discs, the temperature of the discs must rise. This rise in temperature can be measured to determine how much extra braking is being done by the tow vehicle due to the presence of the trailer. This rise in temperature is directly proportional to how much extra work is being done. Therefore, the braking to the trailer can be increased to the point where the tow vehicles brakes are doing a normal (non-towing) level of braking. Should the braking to the trailer be too much, the temperature of the tow vehicle's brakes will decrease, thereby decreasing the braking to the trailer.

In the preferred embodiment, the temperature of the discs is measured by means of a thermocouple pressed against the disc by means of a spring. It is possible to measure the temperature by other means, including an infrared temperature detector. It is also possible to measure the air temperature emitted by the disc cooling fins. Still other means may be possible.

In the preferred embodiment the temperature measurement will be taken into a micro-controller. From here, digital processing can be done to smooth the data, look for changes, find initial conditions and develop a braking algorithm. The micro-controller then formulates the amount of voltage to sent to the trailer brakes from the temperature measurement. The micro-controller can also include acceleration and time into the algorithm to improve the response. Acceleration may still be relied upon for quick braking responses, where the temperature maybe relied upon for more accurate braking response. However, in the preferred embodiment, the temperature response is fast enough to be relied upon alone. Braking may be reduced or increased during the duration the brake is depressed, which may improve the feel of the brakes.

In the preferred embodiment the trailer brakes are controlled through the use of a Proportional+Integral+Differential (PID) controller algorithm in the micro-controller. This algorithm looks at the temperature of the disc brakes above a certain set point, which may change. The temperature above that set point is multiplied by a gain setting to formulate the control signal to the brakes. To this signal is added an integral response which increases with the time. To this signal is added a differential response, which is formulated by subtracting the current brake temperature from past brake information. This results in a great increase in braking when the brake temperatures are climbing, and reduces the braking quickly, should the temperatures drop.

The preferred embodiment will include an operator-controlled input to allow the operator to demand more braking and to act as a back up way of initiating electrical braking to the trailer.

The preferred embodiment will monitor vehicle dynamics, particularly speed to adjust the temperature data for air flow in the brakes. Acceleration may be monitored to improve quick stopping.

The preferred embodiment will also include a gain control setting. This gain control setting will increase how much the electrical brakes are activated given an increase in tow vehicle brakes. This gain control may be changed by use of buttons or knobs on the device.

The preferred embodiment will include a method of reading the state of the petal brake on the tow vehicle, to determine if the operator is currently applying the brake.

The preferred embodiment will include a method of forming a continuously variable voltage to control power to the trailer brakes. This is done in the preferred embodiment by use of pulse width modulation (PWM) of the 12V tow vehicle power.

The preferred embodiment will also include a display to show the operator important information about the system. This will include, but is not limited to, current braking energy, current brake temperatures, gain settings and accelerations. This display may be on the device itself or as a separate display.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1: System schematic drawing showing an embodiment of the present invention

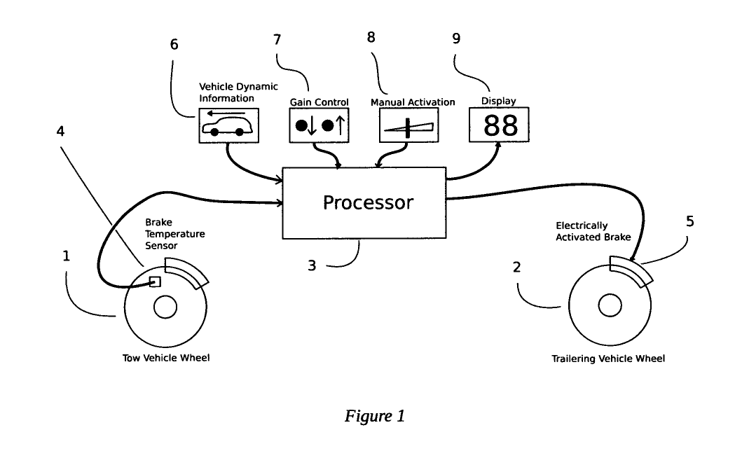

FIG. 2: System Flowchart for processor operations

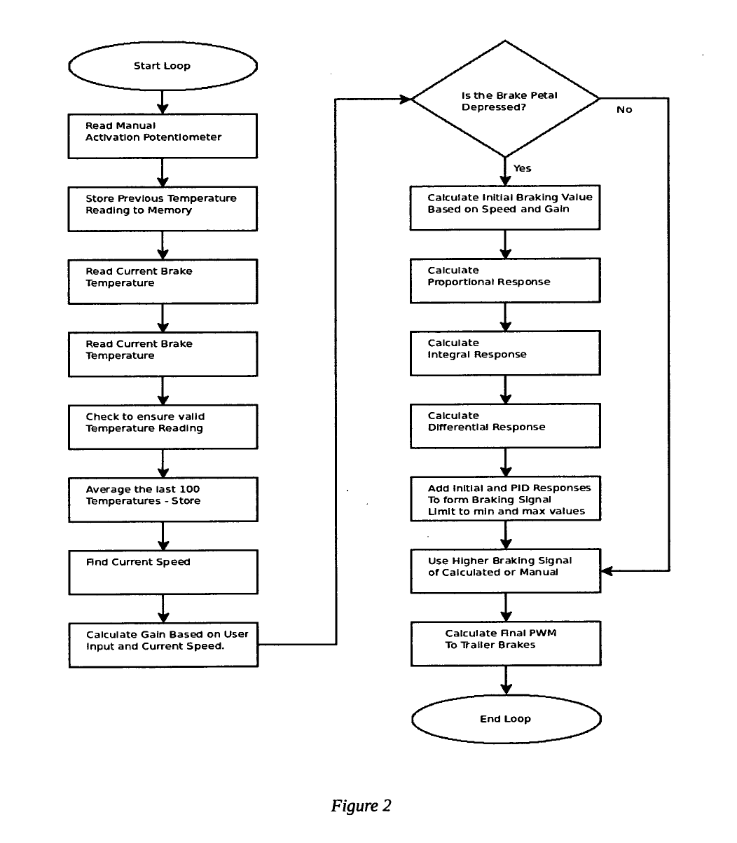

### DETAILED DESCRIPTION OF THE EMBODIMENTS

The invention comprises a brake temperature sensor (4) attached to one of the towing vehicles brakes (1), in the preferred embodiment, the driver's side front wheel. The passenger's front wheel may also be used to have more redundant data. The temperature information is routed to the main processor (3) which in the preferred embodiment is a micro-controller. For the system to work correctly the processor (3) needs to know the dynamic conditions of the vehicle, primarily speed, but acceleration and other attributes maybe useful. In the preferred embodiment this is accomplished using GPS acquired speed by means of a GPS receiver (6), although this could easily be a connection to the vehicle CAN bus (OBD2). The user of the system generally needs a means to inform the processor if the user would like more or less braking. This is done by an up/down set of buttons (7) which the user presses to adjust the gain in the processor (3) feedback control system. Next the user needs a way to activate the brakes manually, in the event of the system not responding correctly, or just a desire to have the trailer do the braking. This is accomplished by means of a slide potentiometer (8) in the preferred embodiment, this may also be done with a touch sensitive pad or a turning potentiometer. The user will also need to see the amount of braking being applied as well as other attributes like system gain, all of which can be displayed by the LCD or LED display (9). When the processor detects a raising brake temperature at the vehicle (1) brake temperature sensor (4), the processor (3) will then calculate the appropriate amount of braking to be applied to the trailering vehicle wheel (2) brake (5). This is typically done by modulating the 12V vehicle power by means of PWM and sending the modulated power to the trailering vehicle's (2) electrically activated brake (5).

What is claimed:

1. A method of controlling trailer brakes using a electrical trailer brake controller in a passenger vehicle, using temperature of one or more of the vehicles braking discs or drums, with the intention of deriving a measurement of braking energy.

2. A method as described in claim 1 using the temperature of the towing vehicles brakes and other data, such as vehicle speed, vehicle acceleration, or vehicle pitch, brake light status to formulate a signal for controlling the trailer brakes.

3. A method of claim 1 using temperature of the tow vehicles brakes in a control loop where the error signal is derived from subtracting a temperature reading from a set point.

4. A method of claim 1, further using a differential of the readings of past temperatures to add to the braking signal.

5. A method of claim 1, further using an integrated or averaged temperature to further correct the braking signal.

6. A method of claim 1, where the error signal is amplified and used to control the electrical brakes of the towed trailer.

7. A method of claim 1, where the error signal is further adjusted using inertial data.

8. A method of claim 1, where the error signal is further adjusting over time.

9. A method of claim 1, where the inertial data is used to identify when the acceleration is changing.

10. A method of claim 9, where the acceleration data is compared to the differential of the temperature data to identify when the vehicle is slowing or stopped.

11. A method of claim 9, where the acceleration data is compared to the differential of the temperature data to identify when the vehicle is speeding up or at speed.

12. A method of claim 3, where the error signal is adjusted in gain by user input

13. A method of claim 4, where the differential portion of the signal is adjusted by user input

14. A method of claim 5, where the integrated signal is adjusted by user input.

15. A method of claim 1, where the signal to the electrical trailer brakes is generated using Pulse Width Modulation of the vehicle supplied power.

16. A method of claim 1, where this signal is adjusted by means of a manual activation by the user.

17. A method of claim 1, where the signal the electrical signal is displayed to the user by means of an electrical display

18. A method of claim 1, where the brake temperatures of the tow vehicle are displayed by means of an electrical display to the user.

19. A method of claim 1, where the brake temperature is acquired through the use of a temperature sensor in direct contract with the braking disc or drum.

20. A method of claim 1, where the brake temperature is acquired through the use of a infrared temperature sensor.
